(19) United States
(12) Patent Application Publication
(10) Pub. No.: US 2024/0241396 A1
(43) Pub. Date: Jul. 18, 2024

(54) OPTICAL WAVEGUIDE DEVICE, AND OPTICAL TRANSMISSION APPARATUS AND OPTICAL MODULATION DEVICE USING SAME

(71) Applicant: SUMITOMO OSAKA CEMENT CO., LTD., Tokyo (JP)

(72) Inventors: Yu KATAOKA, Tokyo (JP); Kosuke OKAHASHI, Tokyo (JP)

(73) Assignee: SUMITOMO OSAKA CEMENT CO., LTD., Tokyo (JP)

(21) Appl. No.: 18/291,679

(22) PCT Filed: Sep. 30, 2021
(86) PCT No.: PCT/JP2021/036106

§ 371 Date: Jan. 24, 2024

(51) Int. Cl. G02F 1/035

(52) U.S. Cl. CPC G02F 1/0356

(57) ABSTRACT

An optical waveguide device in which deterioration of characteristics such as velocity matching, characteristic impedance matching, and an optical loss caused by positional deviation of each electrode layer is suppressed even in a case where a control electrode is formed with a plurality of electrode layers is provided. An optical waveguide device includes a substrate 1 consisting of a material having an electro-optic effect, an optical waveguide 2 formed on the substrate 1, and control electrodes (E1, E2) disposed on the substrate to interpose the optical waveguide between the control electrodes in order to apply an electric field to the optical waveguide 2, in which the control electrodes include at least two or more electrode layers disposed in a sequence of first electrode layers E1 and second electrode layers E2 on the substrate, an insulating layer IL that covers a space between the first electrode layers between which the optical waveguide is interposed and that extends to at least a part of upper surfaces of the first electrode layers is disposed, and at least a part of the second electrode layers E2 is formed on an upper surface of the insulating layer IL.

### TECHNICAL FIELD

The present invention relates to an optical waveguide device, and an optical modulation device and an optical transmission apparatus using the same, and particularly to an optical waveguide device in which a control electrode that applies an electric field to an optical waveguide formed on a substrate is formed with a plurality of electrode layers.

### BACKGROUND ART

In the field of optical measurement technology or in the field of optical communication technology, optical waveguide devices such as an optical modulator using a substrate having an electro-optic effect have been widely used. Particularly, in accordance with an increase in information communication amount in recent years, a high frequency and a large capacity of optical communication used between cities or between data centers at a long distance have been desired. In addition, a high frequency and size reduction of the optical modulator are required because of a restricted space of a base station.

In Patent Literature No. 1, as illustrated in FIG. 1, it is disclosed to implement a design that satisfies all of characteristic impedance matching between electrodes, velocity matching between a microwave and transmitted light, drive voltage characteristics, and an electrode loss by forming electrodes in two stages (E1, E2). In addition, by configuring the electrodes that are required to be formed to be thick for the velocity matching in multiple stages, a thickness of a resist film in forming each electrode layer can be formed to be small. Thus, accuracy of patterning is also improved.

In recent years, there has been further demand for size reduction of a modulator chip such as a high bandwidth-coherent driver modulator (HB-CDM). In the optical modulator reduced in size, a length (action length L) of an action part in which an electric field based on a modulation signal is applied in an optical waveguide is shortened. Thus, VπL which is a product of the action length L and a drive voltage Vπ is decreased. Thus, it is required to increase the drive voltage by narrowing a clearance between a signal electrode and a ground electrode as much as possible, and it is required to form the electrodes with further high accuracy, compared to those in the related art. In the HB-CDM or the like, an optical waveguide that has a narrow width of the optical waveguide and that has strong optical confinement, such as a rib type waveguide or a hybrid waveguide in which a high-refractive index material such as Si is used together, is used.

In the optical waveguide device in FIG. 1, in order to perform a higher-accuracy process, it is required to further thin the electrode layer E1 in the first stage. Accordingly, the electrode layer E2 from the second stage is required to have a narrower clearance between electrode layers (E2) or to be thick.

The graph in FIG. 2 illustrates a relationship between the electrode clearance and the thickness of the electrode in a case where an effective refractive index of the microwave is set to a certain level. As the electrode clearance is widened, a ratio of the thickness of the electrode to the electrode clearance is increased, that is, it is required to form a photoresist that is vertically long. Thus, the resist film is likely to deform by, for example, falling down, and patterning accuracy and yield deteriorate. In FIG. 2, a line with rectangular marks indicates a required thickness (a vertical axis on the left) of the electrode layer (E2) in a case where the clearance between each electrode (E2) has changed, and a line of circular marks indicates a value (a ratio; a vertical axis on the right) obtained by dividing the thickness of the electrode layer (E2) by the electrode clearance.

Thus, the clearance between the electrodes (E2) from the second stage is preferably set to be as small as possible. However, in a case where manufacturing error of the electrodes is large, there is a high probability that a boundary of the electrode layer (E2) deviates to be between the electrodes of the electrode layer (E1) in the first stage, as illustrated in FIG. 3. In this case, an electrode clearance G is narrowed, and various characteristics such as a loss of the transmitted light in addition to the velocity matching and the characteristic impedance matching are significantly affected. FIG. 4 is a graph illustrating a relationship between a positional deviation amount (pattern offset amount) of a pattern of the electrode layer (E2) and an optical loss. As the deviation amount is increased, the optical loss is also increased.

### CITATION LIST

### Patent Literature

[Patent Literature No. 1] Japanese Laid-open Patent Publication No. 2009-145816
[Patent Literature No. 2] Japanese Patent Application No. 2021-050409 (filing date: Mar. 24, 2021)

### SUMMARY OF INVENTION

### Technical Problem

An object to be addressed by the present invention is to address the above issue and to provide an optical waveguide device in which deterioration of characteristics such as velocity matching, characteristic impedance matching, and an optical loss caused by positional deviation of each electrode layer is suppressed even in a case where a control electrode is formed with a plurality of electrode layers. Furthermore, an optical modulation device and an optical transmission apparatus using the optical waveguide device are provided.

### Solution to Problem

In order to address the object, an optical waveguide device of the present invention, and an optical modulation device and an optical transmission apparatus using the same have the following technical features.

(1) An optical waveguide device includes a substrate consisting of a material having an electro-optic effect, an optical waveguide formed on the substrate, and control electrodes disposed on the substrate to interpose the optical waveguide between the control electrodes in order to apply an electric field to the optical waveguide, in which the control electrodes include at least two or more electrode layers disposed in a sequence of first electrode layers and second electrode layers on the substrate, an insulating layer that covers a space between the first electrode layers between which the optical waveguide is interposed and that extends to at least a part of upper surfaces of the first electrode layers is disposed, and at least a part of the second electrode layers is formed on an upper surface of the insulating layer.

(2) In the optical waveguide device according to (1), the optical waveguide is a rib type optical waveguide.

(3) In the optical waveguide device according to (1) or (2), a clearance between the first electrode layers between which the optical waveguide is interposed is less than 10 μm.

(4) In the optical waveguide device according to any one of (1) to (3), a difference between both of a clearance between the first electrode layers between which the optical waveguide is interposed and a clearance between the second electrode layers between which the optical waveguide is interposed is less than 10 μm.

(5) In the optical waveguide device according to any one of (1) to (4), a shape of a corner portion of the insulating layer in contact with lower surfaces of the second electrode layers is a curved surface.

(6) In the optical waveguide device according to any one of (1) to (5), a gap is formed in at least a part of a portion in which the insulating layer and the second electrode layers overlap with each other.

(7) In the optical waveguide device according to any one of (1) to (6), the insulating layer is not formed on at least a part of an upper surface of the optical waveguide, and other control electrodes disposed over the optical waveguide are provided.

(8) In the optical waveguide device according to any one of (1) to (7), the control electrodes are modulation electrodes for applying a modulation signal.

(9) An optical modulation device includes the optical waveguide device according to any one of (1) to (8), a case accommodating the optical waveguide device, and an optical fiber through which a light wave is input into the optical waveguide or output from the optical waveguide.

(10) In the optical modulation device according to (9), the optical waveguide device includes a modulation electrode for modulating a light wave propagating through the optical waveguide, and an electronic circuit that amplifies a modulation signal to be input into the modulation electrode of the optical waveguide device is provided inside the case.

(11) An optical transmission apparatus includes the optical modulation device according to (9) or (10), and an electronic circuit that outputs a modulation signal causing the optical modulation device to perform a modulation operation.

### Advantageous Effects of Invention

In the present invention, an optical waveguide device includes a substrate consisting of a material having an electro-optic effect, an optical waveguide formed on the substrate, and control electrodes disposed on the substrate to interpose the optical waveguide between the control electrodes in order to apply an electric field to the optical waveguide, in which the control electrodes include at least two or more electrode layers disposed in a sequence of first electrode layers and second electrode layers on the substrate, an insulating layer that covers a space between the first electrode layers between which the optical waveguide is interposed and that extends to at least a part of upper surfaces of the first electrode layers is disposed, and at least a part of the second electrode layers is formed on an upper surface of the insulating layer. Thus, even in a case where positional deviation occurs between the first electrode layers and the second electrode layers, a clearance between the control electrodes in heights of the first electrode layers and a clearance between the control electrodes in heights of the second electrode layers do not change. Accordingly, states of velocity matching and characteristic impedance matching do not change. In addition, since the second electrode layers are not close to the optical waveguide, the optical waveguide device in which an optical loss is also suppressed can be provided. Furthermore, an optical modulation device and an optical transmission apparatus using the optical waveguide device in which deterioration of characteristics is suppressed can be provided.

### BRIEF DESCRIPTION OF DRAWINGS

FIG. 1 is a cross-sectional view illustrating an example of an optical waveguide device in the related art disclosed in Patent Literature No. 1.

FIG. 2 is a graph illustrating a relationship between an electrode clearance and a thickness of an electrode.

FIG. 3 is a cross-sectional view illustrating an issue in a case where control electrodes are configured with a plurality of electrode layers as in FIG. 1.

FIG. 4 is a graph illustrating a relationship between a positional deviation amount (pattern offset amount) of an electrode layer and an optical loss.

FIG. 5 is a cross-sectional view illustrating an example of an optical waveguide device according to the present invention.

FIG. 6 is a cross-sectional view illustrating a state in a case where positional deviation of the electrode layer has occurred in the optical waveguide device in FIG. 5.

FIG. 7 is a cross-sectional view illustrating a state in a case where a clearance between second electrode layers is further narrowed in the optical waveguide device in FIG. 5.

FIG. 8 is a diagram illustrating a state where an area in which a first electrode is formed is decreased in the optical waveguide device according to the present invention.

FIG. 9 is a diagram illustrating a state where the number of electrode layers constituting the control electrodes is set to three in the optical waveguide device according to the present invention.

FIG. 10 is an enlarged view of a dotted-line region A in FIG. 5 and is a diagram illustrating a state where a curved surface is disposed on a corner of an insulating layer.

FIG. 11 is an enlarged view of the dotted-line region A in FIG. 5 and is a diagram illustrating a state where a gap is formed between the insulating layer and the second electrode layers.

FIG. 12 is a diagram illustrating a state where the control electrode is disposed on an optical waveguide in the optical waveguide device according to the present invention.

FIG. 13 is a plan view for describing an optical modulation device and an optical transmission apparatus of the present invention.

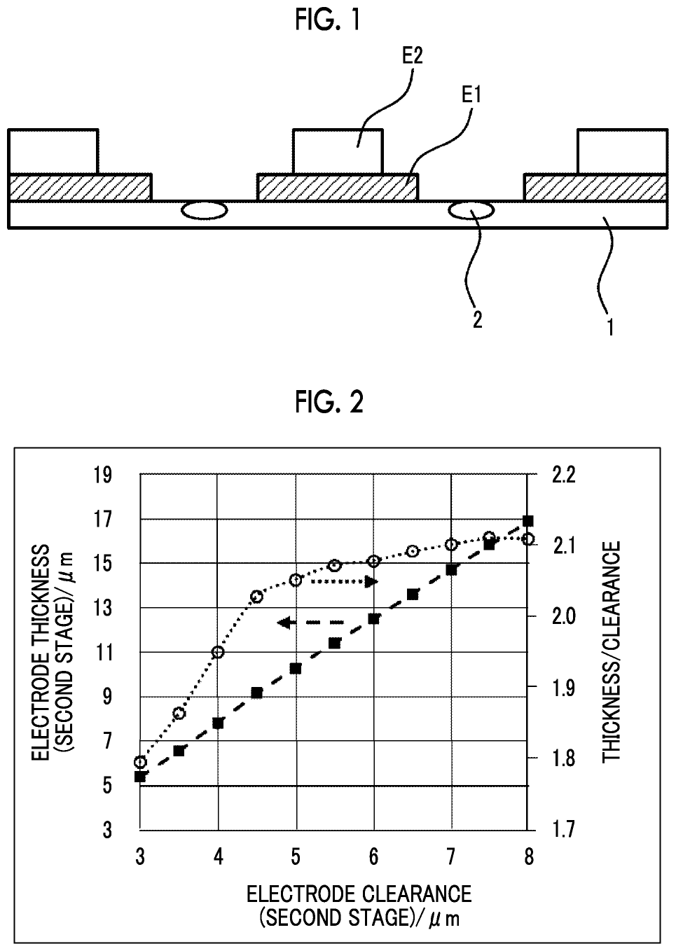

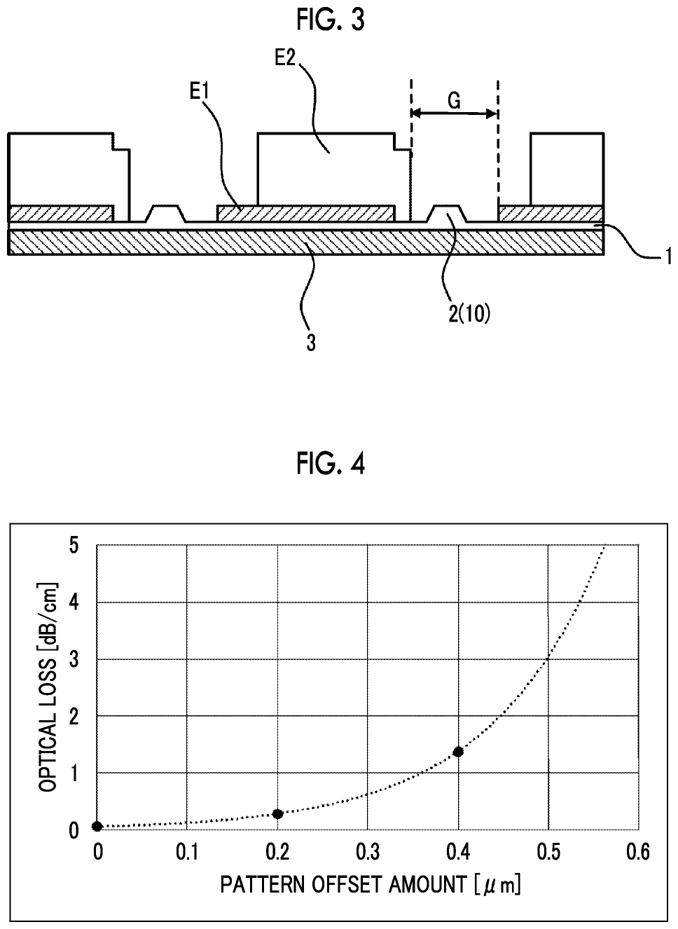

### DESCRIPTION OF EMBODIMENTS

Hereinafter, an optical waveguide device of the present invention will be described in detail using preferred examples.

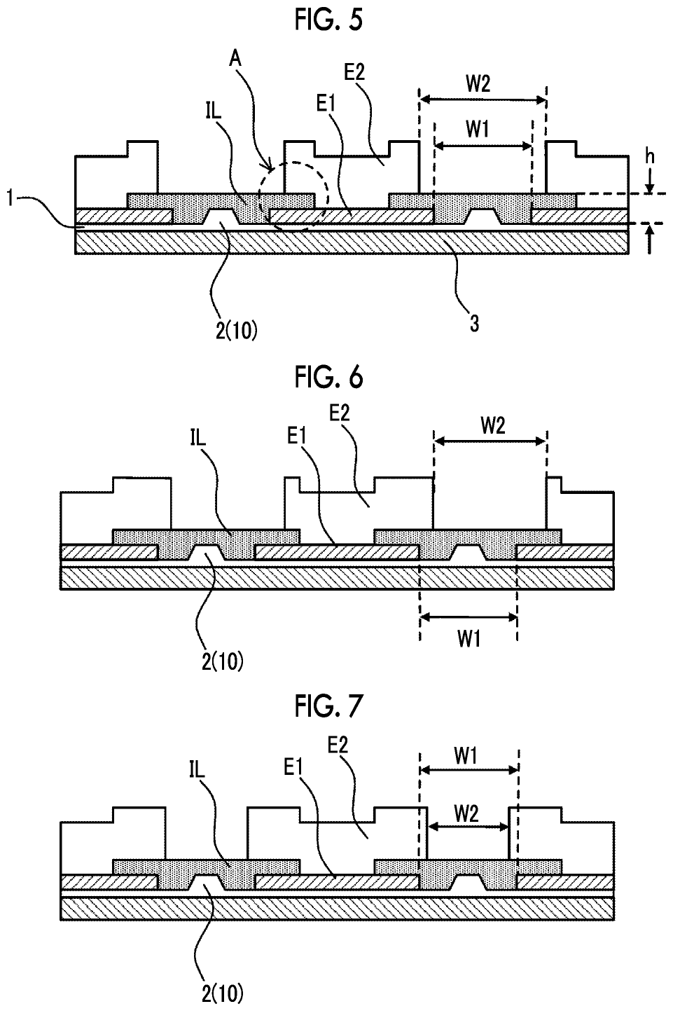

As illustrated in FIG. 5, the optical waveguide device of the present invention includes a substrate 1 consisting of a material having an electro-optic effect, an optical waveguide 2 (a protruding portion 10 of the substrate 1) formed on the substrate 1, and control electrodes (E1, E2) disposed on the substrate to interpose the optical waveguide between the control electrodes in order to apply an electric field to the optical waveguide 2, in which the control electrodes include at least two or more electrode layers disposed in a sequence of first electrode layers E1 and second electrode layers E2 on the substrate, an insulating layer IL that covers a space between the first electrode layers between which the optical waveguide is interposed and that extends to at least a part of upper surfaces of the first electrode layers is disposed, and at least a part of the second electrode layers E2 is formed on an upper surface of the insulating layer IL.

As the substrate 1 having the electro-optic effect used in the optical waveguide device of the present invention, a substrate of lithium niobate (LN), lithium tantalate (LT), lead lanthanum zirconate titanate (PLZT), or the like, a vapor-phase growth film formed of these materials, or the like can be used.

In addition, various materials such as semiconductor materials or organic materials can also be used as the optical waveguide.

As a method of forming the optical waveguide 2, a rib type optical waveguide 10 obtained by forming a part corresponding to the optical waveguide to have a protruding shape in the substrate by, for example, etching the substrate 1 other than the optical waveguide or by forming grooves on both sides of the optical waveguide can be used. Furthermore, a refractive index can be further increased by diffusing Ti or the like on a surface of the substrate using a thermal diffusion method, a proton exchange method, or the like in accordance with the rib type optical waveguide. In addition, while the optical waveguide can be formed by forming a high-refractive index region obtained by thermally diffusing Ti or the like on the substrate 1, the rib type optical waveguide 10 is more preferable because optical confinement is increased by a miniaturized optical waveguide having a width or a height of approximately 1 μm.

A thickness of the substrate (thin plate) 1 on which the optical waveguide 2 is formed is set to 10 μm or less, more preferably 5 μm or less, and still more preferably 1 μm or less in order to achieve velocity matching between a microwave of a modulation signal and a light wave. In addition, a height of the rib type optical waveguide is set to 4 μm or less, more preferably 3 μm or less, and still more preferably 1 μm or less or 0.4 μm or less. In addition, it is also possible to form a vapor-phase growth film on a reinforcing substrate and to process the film to have a shape of the optical waveguide.

The substrate on which the optical waveguide is formed is adhesively fixed to a reinforcing substrate 3 via direct joining or through an adhesive layer of resin or the like as illustrated in FIG. 4 and the like in order to increase mechanical strength. As the reinforcing substrate 3 to be directly joined, a substrate including an oxide layer of a material such as crystal, glass, or the like that has a lower refractive index than a refractive index of the optical waveguide and than a refractive index of the substrate on which the optical waveguide is formed, and that has a similar thermal expansion rate to a thermal expansion rate of the optical waveguide or the like is preferably used. Composite substrates obtained by forming a silicon oxide layer on a silicon substrate and by forming a silicon oxide layer on an LN substrate, which are abbreviated to SOI and LNOI, can also be used.

In the optical waveguide device of the present invention, the insulating layer is disposed between the control electrodes. This means that as the width or the height of the optical waveguide is decreased, roughness of a surface of the optical waveguide significantly affects an optical loss of the light wave propagating through the optical waveguide. For example, in the case of forming a protruding optical waveguide (referred to as the rib type optical waveguide) as the optical waveguide, surface degradation caused by fine roughness may occur on a side surface of the protruding portion depending on an etching speed or on an etching temperature. In order to address such an issue, the present applicants have suggested providing a dielectric layer (insulating layer) that covers the optical waveguide in Patent Literature No. 2.

In the case of the rib type optical waveguide 2 (10) illustrated in FIG. 5, an upper surface and a side surface of the optical waveguide 2 are covered with the insulating layer IL. As will be described later, in the case of forming another control electrode on the optical waveguide, only the side surface or a part of the side surface and the upper surface of the optical waveguide is covered with the insulating layer. In addition, in a case where the optical waveguide forms a high-refractive index region on the substrate 1 via thermal diffusion or the like, the upper surface of the optical waveguide is covered with the insulating layer IL.

The insulating layer IL is preferably a dielectric body having a refractive index higher than 1 and is set to have a refractive index that is 0.5 times or higher and 0.75 times or lower than the refractive index of the optical waveguide 2. A thickness of the insulating layer IL is not particularly limited and can be formed up to a thickness of approximately 10 μm. The thickness and the like of the insulating layer will be described in detail in a later section. In the optical waveguide part including a modulation portion that modulates the light wave by applying a modulation signal to the optical waveguide 2, the optical waveguide 2 functions as a core portion, and the insulating layer functions as a clad portion.

While the insulating layer IL can be formed of an inorganic material such as SiO₂ using a sputtering method or a CVD method, an organic material such as resin may be used. As the resin, a photoresist including a coupling agent (crosslinking agent) can be used, and a so-called photosensitive permanent film (permanent resist) that is cured by a crosslinking reaction developed by heat can be used. As the resin, other materials such as polyamide-based resin, melamine-based resin, phenol-based resin, amino-based resin, and epoxy-based resin can also be used.

As the control electrodes, an underelectrode (Au, Ni, or Ti) is provided on the substrate 1 and is laminated with a metal film of Au or the like using a metal plating method, a vapor deposition method, or the like to form the control electrodes. In performing the metal plating method, a resist film having an opening corresponding to an electrode pattern may be used.

The control electrodes include a modulation electrode that applies the microwave (RF wave) which is the modulation signal, and a bias electrode that applies a DC bias voltage. The control electrodes according to the present invention are mainly effective for the modulation electrode. The structure of the present invention contributes to improving the velocity matching between the modulation signal and the transmitted light, characteristic impedance matching related to the modulation signal, and furthermore, an electrode loss and the like of the modulation signal.

As illustrated in FIG. 5, the control electrodes configured with a plurality of electrode layers and the insulating layer IL that covers the space between the first electrode layers E1 between which the optical waveguide is interposed and that extends to at least the part of the upper surfaces of the first electrode layers E1 are features of the optical waveguide device of the present invention. Of course, the optical waveguide 2 (10) is covered with the insulating layer IL by covering the space between the first electrode layers E1. At least the part of the second electrode layers E2 disposed on the first electrode layers to maintain electrical connection to the first electrode layers is formed on the upper surface of the insulating layer IL.

The “first electrode layers” in the present invention mean electrodes that mainly function in applying the electric field to the optical waveguide, and the “second electrode layers” mean electrodes that mainly function in propagation of the modulation signal through the control electrodes. Of course, the “first electrode layers” can not only be formed with only one layer but also be formed by stacking a plurality of thin layers.

The “at least the part of the second electrode layers formed on the upper surface of the insulating layer” in the present invention not only means a state where the second electrode layers and the insulating layer partially overlap with each other at all times but also means that the present invention also includes a case where the second electrode layers and the insulating layer do not overlap with each other in a case where the second electrode layers are accurately formed and overlap with each other in a case where the second electrode layers have positionally deviated.

In the optical waveguide device of the present invention, as illustrated in FIG. 6, even in a case where the second electrode layers have caused manufacturing error (positional deviation), an electrode clearance W1 between the first electrode layers and an electrode clearance W2 between the second electrode layers are maintained to a certain level. Thus, a state of the electric field applied to the optical waveguide is maintained to a certain level, and characteristic impedance (capacity) is also stabilized.

In addition, by using the structure of the optical waveguide device of the present invention, a design in which the electrode clearance W1 between the first electrode layers and the electrode clearance W2 between the second electrode layers are the same or in which the electrode clearance W2 is narrower than W1 as in FIG. 7 is also possible. This electrode configuration is effective in a case where while it is desired to decrease an effective refractive index of the microwave while suppressing a loss of the transmitted light.

A film thickness h (refer to FIG. 5) of the insulating layer IL of the optical waveguide device of the present invention is preferably greater than a distance from a center of the optical waveguide 2 (10) to the electrodes of the first electrode layers E1, that is, half of the electrode clearance W1 between the first electrode layers E1. Accordingly, a distance between the optical waveguide 2 and the second electrode layers E2 is maintained to a certain level or higher independently of a degree of positional deviation of the second electrode layers, and an increase in the optical loss can be prevented even in a case where electrode manufacturing accuracy of the second electrode layers is low.

In addition, the velocity matching between the microwave and the transmitted light and the characteristic impedance matching can be achieved by adjusting a volume (width/thickness) of the insulating layer IL. However, in a case where the volume of the insulating layer is excessively large, a loss of a high-frequency signal is increased. Thus, the insulating layer is preferably thinner than the electrode clearance.

The first electrode layers can be accurately formed using a thin resist film as disclosed in Patent Literature No. 1. Since the first electrode layers are required to have high positional accuracy and a narrow linewidth with respect to the optical waveguide, maskless exposure based on electron beam drawing or the like is more suitable. The maskless exposure has an exposure time that is increased in proportion to a drawing area. Thus, further reducing the area contributes to manufacturing efficiency. Meanwhile, an electrode layer above the second electrode layers is not required have strict positional accuracy, compared to the first electrode layers. Thus, the electrode layer can be sufficiently stably manufactured by exposure using a photomask without an area constraint.

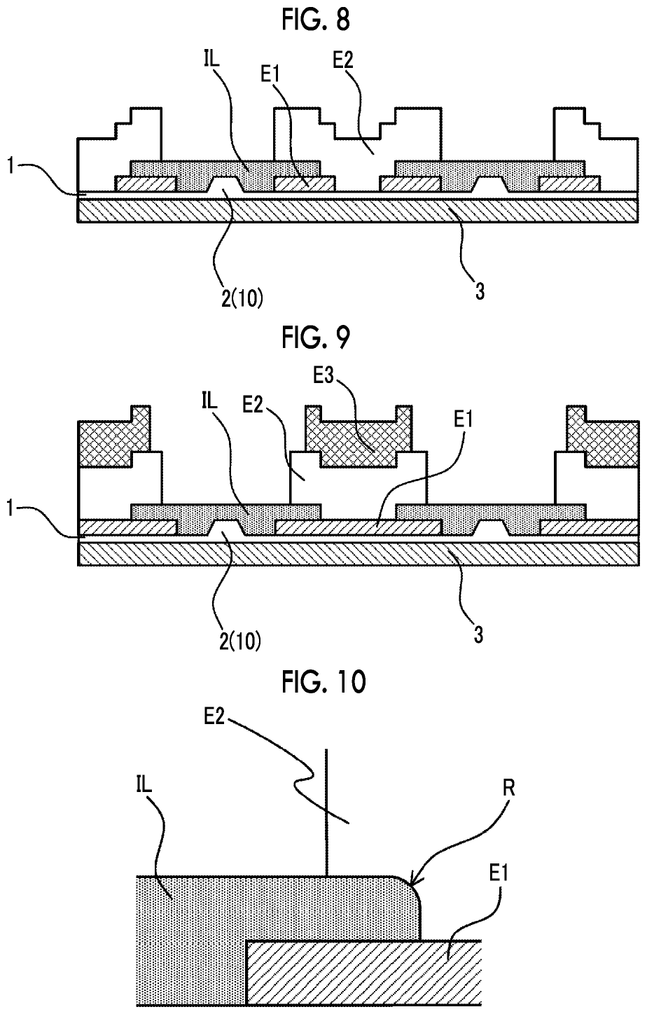

Thus, as illustrated in FIG. 8, by forming the first electrode layers E1 only around a part of an electrode action portion (modulation portion) having a narrow electrode clearance and forming the remaining electrode wiring and the like with the second electrode layers E2, the manufacturing efficiency can be significantly improved.

For example, widths of the electrodes of the first electrode layers (widths of the first electrode layers E1 in a left-right direction in FIG. 8) may have a margin enough to provide sufficient overlap even with the accuracy of electrode formation of the second electrode layers and can be set to 20 μm or less. Accordingly, approximately 80% of the drawing area can be reduced, compared to that in a case where the first electrode layers E1 are disposed on the entire surface under the electrodes of the second electrode layers E2.

In the optical waveguide device illustrated in FIGS. 5 to 8, as the electrode clearance between the first electrode layers E1 is decreased, it is required to thin the electrode, and it is also required to narrow the electrode clearance between the second electrode layers. Thus, it is desirable to apply the electrode clearance W1 between the first electrode layers to be less than 10 μm and more preferably less than 7 μm.

In addition, the structure of the present invention is particularly effective in a case where there is a risk that boundaries of the electrodes of the second electrode layers enter inside boundaries of the electrodes of the first electrode layers. Thus, it is desirable to apply a difference between the electrode clearance between the first electrode layers and the electrode clearance between the second electrode layers to be small, specifically less than 10 μm and more preferably less than 7 μm.

As illustrated in FIG. 9, upper stages (E2, E3) from the second electrode layers may be separately formed through a plurality of times. Accordingly, the entire control electrodes can be formed to be thick, and the electrode loss can be reduced.

The insulating layer IL and the second electrode layers E2 have different linear expansion coefficients. Thus, in a case where the insulating layer IL and the second electrode layers E2 are disposed to overlap with each other, internal stress caused by thermal expansion or the like is generated. Thus, means for alleviating distortion caused by the internal stress is provided in FIGS. 10 and 11. FIGS. 10 and 11 are enlarged views of a dotted-line region A part in FIG. 5.

In FIG. 10, at least a part (particularly a corner portion of the insulating layer IL) of a surface to be joined between the second electrode layers E2 and the insulating layer IL is set to have a curved surface R. Accordingly, stress concentration on edges can be alleviated, and shape stability can be secured.

In FIG. 11, a gap GA is provided between the second electrode layers E2 and the insulating layer IL. Accordingly, an effect of a difference in the expansion rate for each material can be absorbed, and stress applied to a chip (substrate 1) can be alleviated. As a method of forming the gap GA, the gap GA can be formed by, for example, disposing an undermetal E (an undermetal is also disposed in the gap GA) before forming the second electrode layers and etching the undermetal after forming the second electrode layers E2.

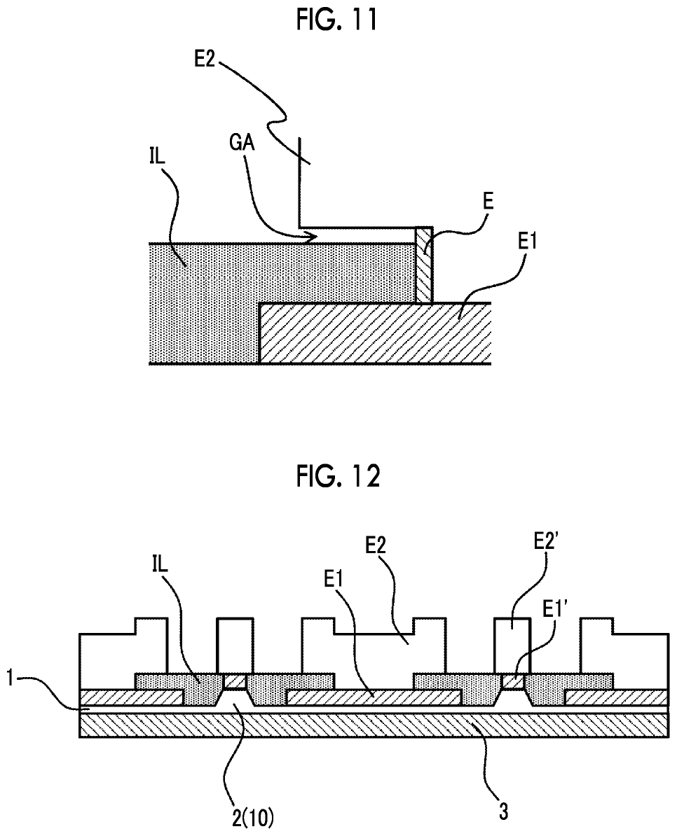

While only the example of the control electrodes between which the optical waveguide 2 is interposed has been described in the above optical waveguide device, other control electrodes (E1′, E2′) can also be disposed on the optical waveguide 2 as an application example, as illustrated in FIG. 12. In this case, the electrode layer E1′ can be formed together in forming the first electrode layers E1, and furthermore, the electrode layer E2′ can be formed together in forming the second electrode layers E2.

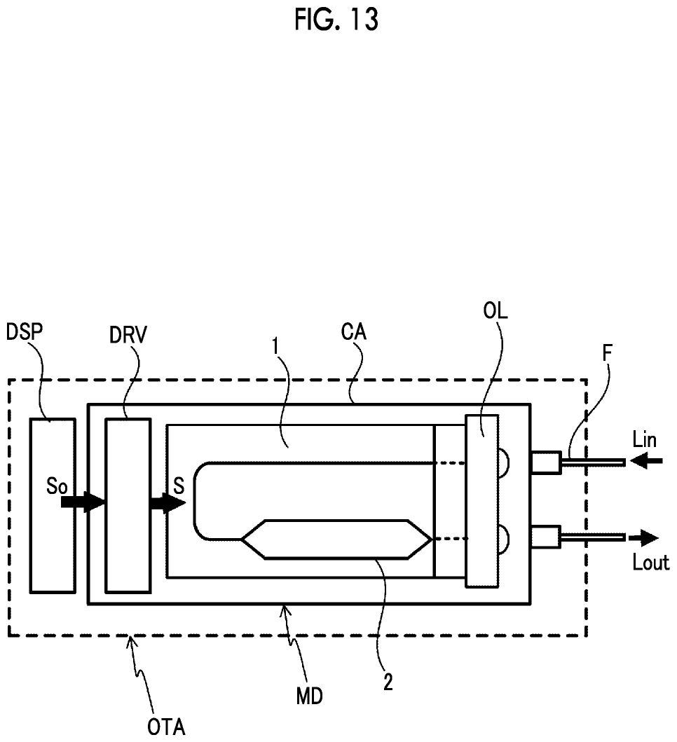

The optical waveguide device of the present invention is provided with a modulation electrode that modulates the light wave propagating through the optical waveguide 2, and the optical waveguide device is accommodated inside a case CA as illustrated in FIG. 13. Furthermore, an optical modulation device MD can be configured by providing an optical fiber (F) through which the light wave is input into the optical waveguide or output from the optical waveguide. In FIG. 13, the optical fiber F is optically coupled to the optical waveguide inside the optical waveguide device using an optical lens OL. The present invention is not limited to the optical fiber F in FIG. 13, and the optical fiber may be directly joined to the optical waveguide device by introducing the optical fiber into the case through a through-hole that penetrates through a side wall of the case.

An optical transmission apparatus OTA can be configured by connecting, to the optical modulation device MD, an electronic circuit (digital signal processor DSP) that outputs a modulation signal causing the optical modulation device MD to perform a modulation operation. The modulation signal to be applied to the optical waveguide device is required to be amplified. Thus, a driver circuit DRV is used. The driver circuit DRV and the digital signal processor DSP can be either disposed outside the case CA or disposed inside the case CA. Particularly, disposing the driver circuit DRV inside the case can further reduce a propagation loss of the modulation signal from the driver circuit.

### INDUSTRIAL APPLICABILITY

As described above, according to the present invention, it is possible to provide an optical waveguide device in which deterioration of characteristics such as velocity matching, characteristic impedance matching, and an optical loss caused by positional deviation of each electrode layer is suppressed even in a case where a control electrode is formed with a plurality of electrode layers. Furthermore, an optical modulation device and an optical transmission apparatus using the optical waveguide device can be provided.

### REFERENCE SIGNS LIST

1: substrate (thin plate, film body) having electro-optic effect
2: optical waveguide
10: rib type optical waveguide
IL: insulating layer
E1: first electrode layer
E2: second electrode layer

1. An optical waveguide device comprising:
a substrate consisting of a material having an electro-optic effect;
an optical waveguide formed on the substrate; and
control electrodes disposed on the substrate to interpose the optical waveguide between the control electrodes in order to apply an electric field to the optical waveguide,
wherein the control electrodes include at least two or more electrode layers disposed in a sequence of first electrode layers and second electrode layers on the substrate,
an insulating layer that covers a space between the first electrode layers between which the optical waveguide is interposed and that extends to at least a part of upper surfaces of the first electrode layers is disposed, and
at least a part of the second electrode layers is formed on an upper surface of the insulating layer.

2. The optical waveguide device according to claim 1, wherein the optical waveguide is a rib type optical waveguide.

3. The optical waveguide device according to claim 1, wherein a clearance between the first electrode layers between which the optical waveguide is interposed is less than 10 μm.

4. The optical waveguide device according to claim 1, wherein a difference between both of a clearance between the first electrode layers between which the optical waveguide is interposed and a clearance between the second electrode layers between which the optical waveguide is interposed is less than 10 μm.

5. The optical waveguide device according to claim 1, wherein a shape of a corner portion of the insulating layer in contact with lower surfaces of the second electrode layers is a curved surface.

6. The optical waveguide device according to claim 1, wherein a gap is formed in at least a part of a portion in which the insulating layer and the second electrode layers overlap with each other.

7. The optical waveguide device according to claim 1, wherein the insulating layer is not formed on at least a part of an upper surface of the optical waveguide, and other control electrodes disposed over the optical waveguide are provided.

8. The optical waveguide device according to claim 1, wherein the control electrodes are modulation electrodes for applying a modulation signal.

9. An optical modulation device comprising:
the optical waveguide device according to claims 1 to 8;
a case accommodating the optical waveguide device; and
an optical fiber through which a light wave is input into the optical waveguide or output from the optical waveguide.

10. The optical modulation device according to claim 9, wherein the optical waveguide device includes a modulation electrode for modulating a light wave propagating through the optical waveguide, and an electronic circuit that amplifies a modulation signal to be input into the modulation electrode of the optical waveguide device is provided inside the case.

11. An optical transmission apparatus comprising:
the optical modulation device according to claim 9; and
an electronic circuit that outputs a modulation signal causing the optical modulation device to perform a modulation operation.
